(19) United States
(12) Patent Application Publication
(10) Pub. No.: US 2026/0204572 A1
(43) Pub. Date: Jul. 16, 2026

(54) ANODE MATERIAL FOR LITHIUM ION CELL

(71) Applicants: POSCO HOLDINGS INC., Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Jung-Gyu WOO, Pohang-si, Gyeongsangbuk-do (KR); Eun-Tae KANG, Pohang-si, Gyeongsangbuk-do (KR); Hyun-Chul JO, Pohang-si, Gyeongsangbuk-do (KR); Seung-Jae YOU, Pohang-si, Gyeongsangbuk-do (KR); Sang-Eun PARK, Hanam-si, Gyeonggi-do (KR)

(73) Assignees: POSCO HOLDINGS INC., Pohang-si, Gyeongsangbuk-do (KR); RESEARCH INSTITUTE OF INDUSTRIAL SCIENCE & TECHNOLOGY, Pohang-si, Gyeongsangbuk-do (KR)

(21) Appl. No.: 19/137,874

(22) PCT Filed: Dec. 15, 2023
(86) PCT No.: PCT/KR2023/020774

§ 371 Date: Jun. 11, 2025

(30) Foreign Application Priority Data
Dec. 16, 2022 (KR) 10-2022-0177432

(51) Int. Cl. H01M 4/587; H01M 4/62

(52) U.S. Cl. CPC H01M 4/587; H01M 4/625

(57) ABSTRACT

One aspect of the present invention provides a Si-carbon composite anode material and a method for preparing same, the Si-carbon composite anode material having nitrogen added to the Si-carbon composite anode material so as to compensate for the low conductivity of an Si raw material, thereby having improved cycle lifespan while also having high efficiency and capacity.

### TECHNICAL FIELD

The present disclosure relates to an anode material for a lithium ion battery and a method of manufacturing the same.

### BACKGROUND ART

Lithium-ion batteries are currently the most widely used secondary battery systems in portable electronic communication devices, electric vehicles, and even energy storage devices. These lithium-ion batteries have advantages, such as high energy density and operating voltage and relatively low self-discharge rate compared to commercial aqueous secondary batteries (Ni—Cd, Ni-MH, etc.), and are thus the focus of attention. However, considering more efficient use time in portable devices and improved energy characteristics in electric vehicles, improvements in electrochemical characteristics still remain as technical issues to be resolved. As a result, research and development is currently being conducted on four major raw materials, including cathodes, anodes, electrolytes, and separators.

Among such raw materials for anodes, graphite-based materials exhibiting excellent capacity retention characteristics and efficiency have been commercialized. However, a relatively low theoretical capacity value (LiC₆: 372 mAh/g) and low discharge capacity ratio of graphite-based materials are somewhat insufficient to meet the high energy and high power density characteristics of batteries required in the market.

Therefore, many researchers have been interested in Group IV elements (Si, Ge, Sn) in the periodic table, and thereamong, Si, in particular, has come to prominence as a very attractive material due to its very high theoretical capacity (Li15Si4: 3600 mAh/g) and low operating voltage (~0.1 V vs. Li/Li+). However, Si undergoes large volume expansion and contraction due to a reaction with lithium during charging and discharging, which may cause fine powder of silicon active material and poor electrical contact between silicon active material powder and a current collector. Due to this phenomenon, the capacity of lithium-ion batteries may rapidly decrease as the charging and discharging cycles proceed.

To overcome such problems, Patent Document 1 provides an exhibiting anode material improved cycle life characteristics with high capacity by including Si particles dispersed in SiO₂, compared to when Si is used alone. However, in addition to Si and SiO₂, an intermediate phase called SiOx (0.55≤x<2) is formed in the anode material, and some of the oxygen in this SiOx may react with Li to form a stable phase, Li₂O. This causes irreversible capacity, which may deteriorate the cycle life characteristics of the anode material.

To solve these problems, research has been actively conducted recently to improve reversibility by compositely combining Si and carbon. However, such Si-carbon composite anode materials may have the problem that high capacity cannot be implemented due to the expansion of Si nanoparticles caused by repeated charging and discharging.

### RELATED ART DOCUMENT

(Patent document 1) Korean Application Publication No. 10-2011-0029087

### SUMMARY OF INVENTION

### Technical Problem

An aspect of the present disclosure is to provide a Si-carbon composite anode material having high capacity and high efficiency characteristics, while having a long cycle life, and a method of manufacturing the same.

### Solution to Problem

According to an aspect of the present disclosure, an anode material for a lithium ion battery includes: Si nanoparticles; a carbon-based material; a carbon matrix; and 0.5 to 5 wt % of nitrogen.

The carbon-based material may include coal-based or petroleum-based pitch including beta resin, graphite and CNT.

The carbon matrix may be carbon derived from at least one of petroleum-based and coal-based pitches having a softening point of 250° C. or less, coal tar, PAA, and PVA.

The coal-based or petroleum-based pitch may have a fixed carbon ratio of 10% or more and includes a beta resin.

The nitrogen included in the anode material may be fully or partially pre-inserted or pre-doped into the Si nanoparticles, the carbon-based material, and the carbon matrix.

The anode material may further include a conductive material. The conductive material may be graphite, CNT, and graphene.

A median particle size of the anode material may be 7 to 15 μm.

The anode material may include 10 to 70 wt % of silicon (Si) and 20 wt % or more of fixed carbon (C).

According to another aspect of the present disclosure, an anode electrode for a lithium ion battery including the anode material is provided.

The anode electrode may have a capacity of 1600 mAh/g or more, an initial efficiency of 87.5% or more, and an expansion rate of 57% or less.

According to another aspect of the present disclosure, a method of manufacturing an anode material for a lithium ion battery includes: preparing Si nanoparticles and a carbon-based material; mixing the Si nanoparticles and the carbon-based material to obtain a mixture; spray-drying the mixture to synthesize a Si-carbon composite; mixing a carbon matrix precursor and a nitrogen-based additive with the Si-carbon composite; press-molding after the mixing; high-temperature firing at 800° C. or higher and lower than 1100° C. after the press-molding; and pulverizing and classifying after the high-temperature firing, wherein the manufactured anode material includes 0.5 to 5 wt % nitrogen.

A median particle size of anode material manufactured by the manufacturing method described above may be 7 to 15 μm.

The Si nanoparticles may be manufactured by a dry milling process, a wet pulverizing method including bead milling or ball milling, a deposition method (thermal deposition or plasma deposition) under a vacuum atmosphere, an electromagnetic melting method, and a co-evaporation method.

In addition, the wet pulverizing method may be performed using an organic solvent including an aqueous system, such as EtOH or IPA.

A median particle size of the Si nanoparticles may be 30 to 500 nm.

A median particle size of the Si-carbon composite may be 6 to 20 μm.

The nitrogen-based additive may be an amine-based, amide-based, aromatic-N-based, carbamates-based, enamine-based, nitramine-based, nitrile-based, imine-based, nitrosamine-based, and organic nitrate-based additive.

The mixing of the carbon matrix precursor and the nitrogen-based additive with the Si-carbon composite may be performed using a mechanofusion, VC, or planetary mixer.

The method may further include an additional coating process, after the pulverizing and classifying.

The anode material manufactured by the manufacturing method described above may include 10 to 70 wt % of silicon (Si) and 20 wt % or more of fixed carbon (C).

### Advantageous Effects of Invention

According to an aspect of the present disclosure, by adding nitrogen to the Si-carbon composite anode material to supplement low conductivity (10⁻⁴ S/cm) of the Si raw material, a Si-carbon composite anode material having improved cycle life and high efficiency and capacity and a method of manufacturing the same may be provided.

### BRIEF DESCRIPTION OF DRAWINGS

FIG. 1 is a graph of capacity (mAh/g) according to a N content (%) measured in <composite-only evaluation>.

FIG. 2 is a graph of initial efficiency (%) according to a N content (%) measured in <composite-only evaluation>.

FIG. 3 is a graph of an expansion rate (%) according to a N content (%) measured in the <graphite comprehensive evaluation>.

### BEST MODE FOR INVENTION

Hereinafter, embodiments of the present disclosure will be described. However, the embodiments of the present disclosure may be modified in various other forms, and the scope of the present disclosure is not limited to the embodiments described below. In addition, the embodiments of the present disclosure are provided to more completely describe the present disclosure to those skilled in the art.

In this specification, the term “include” is used to indicate that other components may not be excluded but be included unless specifically stated otherwise.

In addition, in the specification of the present disclosure, the % unit indicates weight % unless specifically stated otherwise.

An anode material according to an embodiment of the present disclosure may include Si nanoparticles; a carbon-based material; a carbon matrix; and 0.5 to 5 wt % of nitrogen.

That is, an embodiment of the present disclosure targets a silicon-based anode material including Si nanoparticles. The anode material may include Si nanoparticles, thereby implementing a high-capacity battery compared to a carbon-based anode material. In addition, in an embodiment of the present disclosure, the Si nanoparticles may target fine particles having a median particle size (D50) of 30 to 500 nm. The median particle size refers to a particle size at the center of a particle size distribution obtained when measured by a particle size analyzer from Beckmann Coulter. Also, for surface stability, the Si nanoparticles may include a carbon coating layer.

The carbon-based material included in the anode material prevents the Si nanoparticles from expanding and secures the conductivity of the anode material. The carbon-based material may include graphite and CNT having orientation and may also include coal-based or petroleum-based pitch including beta resin.

The carbon matrix enables the Si-carbon composite to be well formed on a carbon support layer, improves electrical contact of Si particles existing inside/outside the Si-carbon composite, and secures the densification within the anode material. Although not necessarily limited thereto, the carbon matrix included in the anode material may include carbon derived from at least one of petroleum-based and coal-based pitch having a softening point of 250° C. or less, coal tar, PAA, and PVA. At this time, the carbon may be carbonized carbon. Preferably, the coal-based or petroleum-based pitch may have a fixed carbon ratio of 10% or more and may include beta resin.

The aforementioned anode material may include 0.5 to 5 wt % of nitrogen. As described above, by adding nitrogen, the present disclosure may improve the electrical conductivity of Si nanoparticles. If the nitrogen content is less than 0.5%, such an effect cannot be secured, and a more preferable lower limit is 0.6%. Meanwhile, if the nitrogen content exceeds 5%, the absolute amount of Si and graphite capable of expressing capacity may decrease, making it difficult to secure high capacity of the anode material. A more preferable upper limit is 4.5%.

At this time, nitrogen may be doped through various methods, and as an example of implementation, there may be a method of adding an organic or inorganic compound including nitrogen and performing heat treatment, and a doping method utilizing nitrogen plasma.

In addition, the in the nitrogen included aforementioned anode material may exist in a form in which all or part thereof is pre-inserted or pre-doped into the Si nanoparticles, carbon-based material, and carbon matrix.

The anode material may further include a conductive material having excellent conductivity in order to improve cycling efficiency during charge-discharge, and preferably, graphite, CNT, or graphene may be added thereto.

In addition, a median particle size of the anode material may be 7 to 15 μm. If the median particle size exceeds 15 μm, an electrode may expand excessively during charge-discharge, which may deteriorate the lifespan of the electrode. A more preferable upper limit is 12 μm, and an even more preferable upper limit is 11 μm. Meanwhile, if the median particle size is less than 7 μm, the specific surface area may increase due to an increase in the number of particles, which may cause a problem of decreased charge-discharge efficiency. A more preferable lower limit is 8 μm.

According to an embodiment, the anode material of the present disclosure may include 10 to 70 wt % of Si and 20 wt % or more of fixed carbon.

If the Si is included in an amount greater than 70 wt %, the electrode may expand due to repeated charging and discharging, and the cycle life may be shortened due to this. A more preferable upper limit is 68%, and an even more preferable upper limit is 65%. Meanwhile, in order to provide a high-capacity Si-carbon composite anode material, it is preferable that the Si nanoparticles include 10 wt % or more of Si nanoparticles. A more preferable lower limit is 20%, and an even more preferable lower limit is 55%.

In addition, the anode material may include a fixed carbon ratio of 20 wt % or more. If the fixed carbon is included in an amount of less than 20%, a large amount of pores may occur, which may cause a side reaction with an electrolyte, thereby causing a problem in which the lifespan of the anode material is deteriorated. A more preferable lower limit is 25%, and an even more preferable lower limit is 30%.

An anode electrode for lithium ions including the Si-carbon composite anode material according to the present disclosure exhibits high-capacity characteristics and excellent cycle life characteristics. Preferably, an ion electrode for lithium ions including the anode material according to the present disclosure may have a capacity of 1600 mAh/g or more, an initial efficiency of 87.5% or more, and an expansion ratio of 57% or less.

The method of manufacturing an anode material according to the present disclosure may include preparing Si nanoparticles and a carbon-based material; mixing the Si nanoparticles and the carbon-based material to obtain a mixture; spray-drying the mixture to manufacture a Si-carbon composite; mixing a carbon matrix precursor and a nitrogen-based additive with the Si-carbon composite; and press-molding after the mixing; high-temperature firing at 800° C. or more and less than 1100° C. after the press-molding; and pulverizing and classifying after the high-temperature firing. In addition, the manufactured anode material may include 0.5 to 5 wt % of nitrogen.

The Si nanoparticles manufactured by a dry milling process, a wet pulverizing method, such as bead milling, ball milling, a deposition method (thermal deposition, plasma deposition, etc.) manufactured under a vacuum atmosphere, an electromagnetic melting method, or a co-evaporation method may be used. Preferably, a wet pulverizing method capable of minimizing the oxidation degree of Si nanoparticles and easily controlling the particle size may be used.

The wet pulverizing method may be performed using an organic solvent: an aqueous system, and as a preferred embodiment, EtOH and IPA may be used to prevent oxidation of Si.

A median particle size of the Si nanoparticles may be 30 to 500 nm. If the particle size of the Si nanoparticles exceeds 500 nm, the capacity may increase, but the lifespan of the electrode may be deteriorated due to the expansion problem of the electrode. A more preferable upper limit is 250 nm, and an even more preferable upper limit is 200 nm. Meanwhile, if the particle size of the Si nanoparticles is less than 30 nm, there is a problem that the high capacity characteristics of the anode material cannot be secured. More preferably, the median particle size of the Si nanoparticles may be 50 nm or more.

Thereafter, the Si nanoparticles and the carbon-based material may be mixed in the presence of a solvent, and the mixture may be spray-dried to form a Si-carbon composite, and the solvent may be dried. In an embodiment of the present disclosure, the solvent may be a solvent used when pulverizing the Si nanoparticles, but is not necessarily limited thereto.

In a preferred embodiment, the median particle size of the Si-carbon composite formed after mixing may be 6 to 20 μm. If the particle size of the Si-carbon composite exceeds 20 μm, large volume expansion and shrinkage may occur, which may deteriorate the cycle life characteristics of the electrode. A more preferred upper limit is 15 μm, and an even more preferred upper limit is 12 μm. Meanwhile, if the particle size of the Si-carbon composite is less than 6 μm, decrease and the charge/discharge the efficiency may capacity may rapidly decrease. More preferably, the particle size of the Si-carbon composite may be 8 μm or more. Variables affecting the size of the Si-carbon composite may include the conditions of spray drying (a solid content ratio, a rotation speed of spray drying) and the particle size of graphite to be mixed.

After spray drying, a carbon matrix precursor and a nitrogen-based additive may be mixed with the Si-carbon composite.

The carbon matrix precursor may be at least one of petroleum-based and coal-based pitches having a softening point of 250° C. or less, coal tar, PAA, and PVA, and the petroleum-based and coal-based pitches may have a fixed carbon ratio of 10% or more and may include beta resin.

Since the nitrogen-based additive includes all organic substances including nitrogen, the nitrogen-based additive may be amine-based, amide-based, aromatic-N-based, carbamates-based, enamine-based, nitramine-based, nitrile-based, imine-based, nitrosamine-based, or organic nitrate-based but is not limited thereto.

In addition, the Si-carbon precursor, carbon matrix precursor, and nitrogen-based additive may be evenly dispersed by the mixing. The mixing method is not specifically limited within the range in which the purpose may be achieved, but as an example, the mixing may be performed using a mechanofusion, VC, or planetary mixer.

After the mixing, the mixture may be press-molded. Through the press-molding, pores existing inside the Si nanoparticle-carbon precursor may be minimized, and a high-density anode material may be manufactured by increasing cohesion force of each constituent particle. The pressure and pressing time in the press-molding operation are not particularly limited within the range that may achieve the aforementioned purpose.

After the press-molding, high-temperature firing may be performed at 800° C. or higher and less than 1100° C. Through the high-temperature firing, volatile substances may be removed and a carbon support layer may be formed. Such an effect cannot be secured at less than 800° C. A more preferable lower limit is 850° C., and an even more preferable lower limit is 900° C. However, at 1100° C. or higher, the charge/discharge capacity and efficiency may be reduced due to a side reaction of the Si nanoparticles. A more preferable upper limit is 1000° C., and an even more preferable upper limit is 950° C.

After the high-temperature firing, pulverizing and classifying may be performed to manufacture a lithium-ion battery anode material having a median particle size of 7 to 15 μm.

Meanwhile, an embodiment of the present disclosure may further include coating the surface of the pulverized particles after the pulverization and classification. Through the additional coating, the surface of partially exposed Si may be protected and the remaining pores may be filled, thereby securing long-term lifespan characteristics.

The anode material manufactured by the manufacturing method described above may include 10 to 70 wt % of silicon (Si) and 20 wt % or more of fixed carbon (C).

### MODE FOR INVENTION

### Example

In this experiment, EtOH was used as a solvent and a wet bead mill was used to obtain Si nanoparticles in a slurry state. The median particle size of the Si nanoparticles was 100 nm. Thereafter, the Si nanoparticles were mixed with graphite and spray-dried to manufacture a Si-graphite composite. At this time, the particle size of the Si-graphite composite was 18 to 20 μm based on D50. When pitch is mixed with the product, hexametylenetetramine (hereinafter referred to as HMT) or melamine was added in the amount shown in Table 1 for nitrogen doping, and the mixing was performed through a mechanofusion process. Thereafter, a molded body was manufactured using a pressure molding machine, and the molded body was heat-treated at a temperature range of about 1000° C. and under an inert atmosphere. At this time, the density of the molded body was 1 to 1.3 g/cc. After the heat treatment, a pulverizing and classifying and an additional carbon coating process were performed to obtain the final product. At this time, the particle size of the final product was confirmed to be about 7 to 15 μm based on D50. In addition, a composition ratio was 45 to 48 wt % for Si and 20 wt % or more for fixed carbon.

The nitrogen content of the obtained final product was measured using a nitrogen/oxygen determinator (LECO) analyzer and is shown in Table 1.

### <Composite-Only Evaluation>

After obtaining the anode active material, the synthesized Si-carbon composite anode active material was coated on a Cu current collector to have a loading amount of 5 mg/cm² and an electrode density of 1.2 to 1.3 g/cc for electrochemical characteristic analysis, and then rolled. A CR2032 type coin half cell was manufactured and a charge-discharge test was performed in an operating voltage range of 0.005 V to 1.0 V. The binder used for electrode manufacturing was a polyacrylic acid (PAA) system, and the electrolyte was EC:DEC=1:1 (1.0 M LiPF₆) without additives. The current during charge-discharge was measured at 0.1 C at an initial cycle. The capacity and initial efficiency measured through the process are shown in Table 1.

### <Graphite Mixed Evaluation>

After mixing 80 wt % of commercial natural graphite and 20 wt % of synthetic Si-carbon composite anode material, a coin half cell with a anode capacity of 600 mAh/g and a commercial LCO as a cathode was manufactured. Thereafter, the capacity and efficiency of the anode electrode were checked through 0.1 C (charge)/0.1 C (discharge), a long-term lifespan was measured through 0.5 C (charge)/0.5 C (discharge), and the measured capacity and initial efficiency are shown in Table 1. The composition of the anode electrode was active material:conductive material:CMC:SBR=96.1:1:1.4:1.5, and a rolling density was 1.4 g/cc. The electrolyte used an additive of VC 1.0% and FEC 10%, and EC:DEC=1:1 (1.0 M LiPF₆). In order to measure an expansion rate of the mixed electrode, a coin half cell was used. After the 50th cycle was completed, the coin cell was fully charged to 0.005 V (0.005 C cut-off) and then decomposed, and a thickness of the charged electrode was measured to compare an expansion rate change trend. Corresponding results are shown in Table 1.

TABLE 1

| | | | Result of | Composite-only | | | | |
|---|---|---|---|---|---|---|---|---|
| | | | measuring | evaluation | | Graphite Mixed Evaluation | | |
| | | Amount of | nitrogen | | Initial | | Initial | Expansion |
| | | addition | content | Capacity | efficiency | Capacity | efficiency | (%@50 |
| | Additive | (wt %) | (wt %) | (mAh/g) | (%) | (mAh/g) | (%) | cycle) |
| Example 1 | HMT | 1.0 | 0.52 | 1621 | 87.5 | 624.81 | 90.7 | 57 |
| Example 2 | HMT | 3.0 | 1.23 | 1618 | 87.6 | 624.18 | 90.7 | 55 |
| Example 3 | HMT | 5.0 | 2.25 | 1617 | 88.0 | 623.97 | 91.1 | 53 |
| Example 4 | HMT | 7.0 | 3.45 | 1610 | 88.2 | 622.50 | 91.3 | 52 |
| Example 5 | Melamine | 1.0 | 0.75 | 1617 | 87.6 | 623.97 | 90.7 | 55 |
| Example 6 | Melamine | 3.0 | 1.85 | 1615 | 87.8 | 623.55 | 90.9 | 54 |
| Example 7 | Melamine | 5.0 | 2.87 | 1609 | 87.9 | 622.29 | 91 | 52 |
| Example 8 | Melamine | 7.0 | 4.25 | 1605 | 88.2 | 621.45 | 91.3 | 52 |
| Comparative | — | 0.0 | 0 | 1625 | 87.0 | 625.65 | 90.1 | 58 |
| Example 1 | | | | | | | | |
| Comparative | HMT | 20.0 | 7.25 | 1575 | 86.5 | 615.15 | 89.5 | 57 |
| Example 2 | | | | | | | | |
| Comparative | Melamine | 20.0 | 9.58 | 1555 | 85.8 | 610.95 | 88.9 | 59 |
| Example 3 | | | | | | | | |

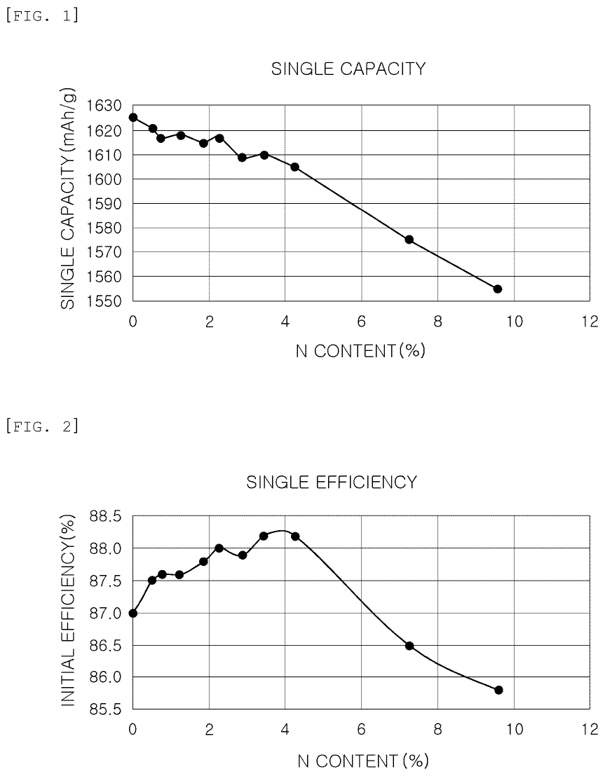

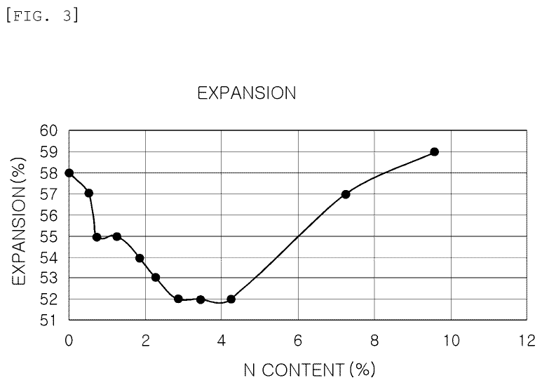

Referring to FIGS. 1 to 3, as the nitrogen content increased to 5 wt %, the capacity decrease was minimal, but the initial efficiency increased and the expansion rate decreased.

However, in the case of an anode electrode including an anode material with a nitrogen content exceeding 5%, the capacity and initial efficiency decreased rapidly, and the expansion characteristics also deteriorated rapidly.

In the case of Comparative Example 1, since it did not include any nitrogen at all, it was not able to compensate for the low electrical conductivity of Si, and thus the initial efficiency was low and the expansion rate was high.

In addition, In Comparative Examples 2 to 3, nitrogen contents exceeded 5%, and the capacity and initial efficiency decreased rapidly. This is because, when nitrogen exceeded a certain content, the absolute amount of Si and graphite capable of expressing the capacity decreased.

Meanwhile, Inventive Examples 1 to 8 included a nitrogen content of 0.5 to 5 wt %, and thus, it can be seen that the corresponding electrodes were able to have high capacity and efficiency high characteristics, while alleviating the expansion of Si particles.

1. An anode material for a lithium ion battery, the anode material comprising:
Si nanoparticles;
a carbon-based material;
a carbon matrix; and
0.5 to 5 wt % of nitrogen.

2. The anode material of claim 1, wherein the carbon-based material includes coal-based or petroleum-based pitch including beta resin, graphite and CNT.

3. The anode material of claim 1, wherein the carbon matrix is carbon derived from at least one of petroleum-based and coal-based pitches having a softening point of 250° C. or less, coal tar, PAA, and PVA.

4. The anode material of claim 3, wherein the coal-based or petroleum-based pitch has a fixed carbon ratio of 10% or more and includes a beta resin.

5. The anode material of claim 1, wherein the nitrogen included in the anode material is fully or partially pre-inserted or pre-doped into the Si nanoparticles, the carbon-based material, and the carbon matrix.

6. The anode material of claim 1, wherein the anode material further includes a conductive material.

7. The anode material of claim 6, wherein the conductive material is graphite, CNT, and graphene.

8. The anode material of claim 1, wherein a median particle size of the anode material is 7 to 15 μm.

9. The anode material of claim 1, wherein the anode material includes 10 to 70 wt % of silicon (Si) and 20 wt % or more of fixed carbon (C).

10. A method of manufacturing an anode material for a lithium ion battery, the method comprising:
preparing Si nanoparticles and a carbon-based material;
mixing the Si nanoparticles and the carbon-based material to obtain a mixture;
spray-drying the mixture to synthesize a Si-carbon composite;
mixing a carbon matrix precursor and a nitrogen-based additive with the Si-carbon composite;
press-molding after the mixing;
high-temperature firing at 800° C. or higher and lower than 1100° C. after the press-molding; and
pulverizing and classifying after the high-temperature firing,
wherein the manufactured anode material includes 0.5 to 5 wt % nitrogen.

11. The method of claim 10, wherein the Si nanoparticles are manufactured by a dry milling process, a wet pulverizing method including bead milling or ball milling, a deposition method (thermal deposition or plasma deposition) under a vacuum atmosphere, an electromagnetic melting method, and a co-evaporation method.

12. The method of claim 10, wherein a median particle size of the Si nanoparticles is 30 to 500 nm.

13. The method of claim 10, wherein a median particle size of the Si-carbon composite is 6 to 20 μm.

14. The method of claim 10, wherein the nitrogen-based additive is an amine-based, amide-based, aromatic-N-based, carbamates-based, enamine-based, nitramine-based, nitrile-based, imine-based, nitrosamine-based, and organic nitrate-based additive.

15. The method of claim 10, further comprising an additional coating process, after the pulverizing and classifying.
